(19) United States
(12) Patent Application Publication
(10) Pub. No.: US 2016/0240309 A1
(43) Pub. Date: Aug. 18, 2016

(54) METHOD FOR DEPOSITING A COMPOSITE FILM ON A PERMANENT NEODYMIUM-IRON-BORN MAGNET

(71) Applicant: Yantai Shougang Magnetic Materials Inc., Yantai City (CN)

(72) Inventors: Daoning Jia, Yantai City (CN); Zhongjie Peng, Yantai City (CN); Kunkun Yang, Yantai City (CN)

(21) Appl. No.: 15/042,287

(22) Filed: Feb. 12, 2016

(30) Foreign Application Priority Data
Feb. 12, 2015 (CN) 201510078214.5

(51) Int. Cl. H01F 41/02

(52) U.S. Cl. CPC H01F 41/026

(57) ABSTRACT

A method for depositing a composite film on a permanent Nd—Fe—B magnet including step of spraying the anti-corrosive film of a composite resin selected from one of epoxy and phenol on the coated permanent Nd—Fe—B magnet and curing the layered permanent Nd—Fe—B magnet at a first final temperature of 120° C. for a first time interval of 30 minutes and at a second final temperature of 170° C. for a second time interval of 30 minutes. The method also includes a step of cooling the chamber by feeding a fluid of water at a cooling temperature of between 0° C. and 5° C. through the chamber and the arc source. The method further includes a step of adjusting the target source of metal and a control magnet of the arc source defining a predetermined distance of between 1 cm and 10 cm between the target source of metal and the control magnet of the arc source.

### CROSS REFERENCE TO RELATED APPLICATION

This application claims the benefit of a Chinese application having a serial number of 201510078214.5, published as CN 104674169 A, and filed on Feb. 12, 2015.

### BACKGROUND OF THE INVENTION

1. Field of the Invention

The present invention generally relates to a method for depositing a composite film on a permanent Nd—Fe—B magnet.

2. Description of the Prior Art

Because permanent Nd—Fe—B magnets contain large amounts of rare earth elements, the permanent Nd—Fe—B magnets can be easily oxidized when it is exposed to air or under a damp environment. Accordingly, the magnetic properties of the permanent Nd—Fe—B magnets are reduced and, therefore, cannot function properly. In order to prevent oxidation, many manufacturers have deposited an anti-corrosive layer on the surface of the permanent Nd—Fe—B magnets. With increasingly wide range of applications and requirements for the permanent Nd—Fe—B magnets, conventional methods for depositing anti-corrosion layers on the permanent Nd—Fe—B magnets no longer meet the requirements. For example, offshore wind power projects often require the permanent Nd—Fe—B magnets to have more than 1,000 hours of corrosion resistance. Such a requirement cannot be achieved using aluminum coating and epoxy coating and having a thickness of less than 50 μm.

Because aluminum has a greater anti-corrosion property, there has been a constant development in the aluminum plating technologies. Often, manufacture defects present on the surface of the permanent Nd—Fe—B magnets can be rectified using aluminum plating. Electrophoresis plating can be used to deposit a composite layer on the permanent Nd—Fe—B magnets; however, the portion of the permanent Nd—Fe—B magnets that engages the jig of the electrophoresis plating machine rusts easily thereby can be easily corroded.

Such a method is disclosed in Chinese Patent Publication CN102108510 A. The method includes a step of removing grease and dust from a permanent Nd—Fe—B magnet to produce a purified permanent Nd—Fe—B magnet. The next step of the method is disposing the purified permanent Nd—Fe—B magnet in a chamber of a multi-arc ion plating apparatus. Then, air is removed from the chamber of the multi-arc ion plating apparatus to lower pressure in the chamber of the multi-arc ion plating apparatus to a first reduce pressure. Next, an electric potential is applied to the purified permanent Nd—Fe—B magnet in the chamber of the multi-arc ion plating apparatus to clean the purified permanent Nd—Fe—B magnet. The method also includes a step of depositing a first film of metal on the purified permanent Nd—Fe—B magnet using an arc source to produce a coated permanent Nd—Fe—B magnet. The method further includes a step of depositing an anti-corrosive film on the coated permanent Nd—Fe—B magnet to produce a layered permanent Nd—Fe—B magnet.

### SUMMARY OF THE INVENTION

The invention provides for such a method wherein he step of depositing the anti-corrosive film is further defined as spraying the anti-corrosive film of a composite resin on the coated permanent Nd—Fe—B magnet.

### ADVANTAGES OF THE INVENTION

The present invention overcomes the shortages of the existing technologies, and provides a method for depositing a composite film on a permanent Nd—Fe—B magnet.

The present invention reduces the amount of ion clusters formed at the arc source which reduces the formation of large liquids and large particles on the surface of the permanent Nd—Fe—B magnet. The present invention also provides for an increased efficiency of depositing the film of metal on the purified permanent Nd—Fe—B magnet. In addition, the present invention provides for the film of aluminum having improved adhesion to the permanent Nd—Fe—B magnet and a smoother surface on the permanent Nd—Fe—B magnet. Furthermore, the present invention provides for an improved corrosion resistance for the permanent Nd—Fe—B magnet.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic flow chart in accordance with the present invention.

### DESCRIPTION OF THE ENABLING EMBODIMENT

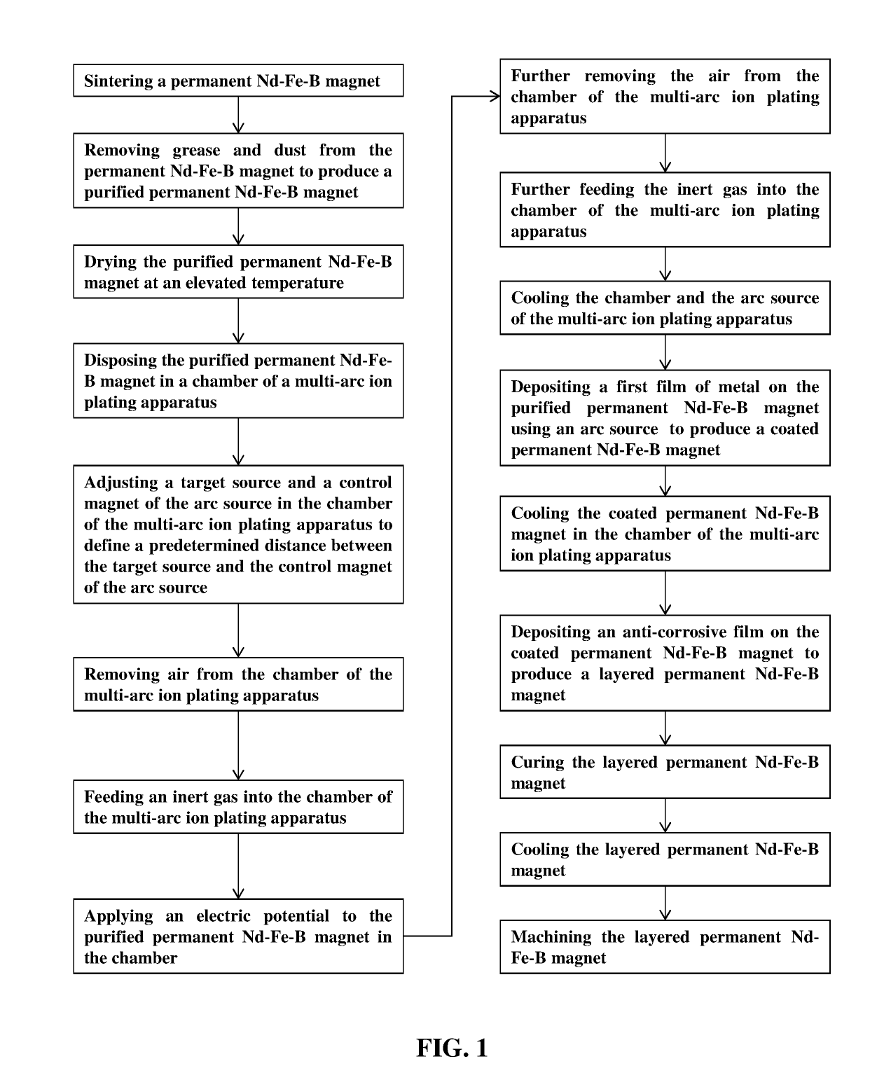

Referring to the Figures, wherein like numerals indicate corresponding parts throughout the several views, a method for depositing a composite film on a permanent Nd—Fe—B magnet including grease and dust is generally shown in FIG. 1. The method uses a multi-arc ion plating apparatus. The multi-arc ion plating apparatus defines a chamber and includes a target source of metal disposed in the chamber. A jig is disposed in the chamber and rotatably attached to the multi-arc ion plating apparatus. An arc source including a control magnet is disposed in the chamber of the multi-arc ion plating apparatus.

The method includes a step of removing grease and dust from the permanent Nd—Fe—B magnet to produce a purified permanent Nd—Fe—B magnet. The step of removing the grease and the dust further includes a step of washing the permanent Nd—Fe—B magnet using deionized water. After washing the permanent Nd—Fe—B magnet, the permanent Nd—Fe—B magnet is rinsed using an acidic solution including nitric acid being present in an amount between 3.0 wt % and 5.0 wt % to remove the grease. Next, after rinsing the permanent Nd—Fe—B magnet, the permanent Nd—Fe—B magnet is washed using the deionized water. Then, the permanent Nd—Fe—B magnet is subjected to an ultrasonic rinsing process to remove the dust.

Because the deionized water used to wash the permanent Nd—Fe—B magnet may be retained in the permanent Nd—Fe—B magnet, the step of removing the grease and the dust further includes a step of removing the deionized water from the permanent Nd—Fe—B magnet by submerging the permanent Nd—Fe—B magnet in a solution including alcohol being present of at least 99 wt. % to remove the deionized water from the permanent Nd—Fe—B magnet. After removing the deionized water from the permanent Nd—Fe—B magnet, the permanent Nd—Fe—B magnet is air-dried to produce the purified permanent Nd—Fe—B magnet.

It should be appreciated that, prior to the step of removing the grease and the dust, the method may further include a step of sintering a permanent Nd—Fe—B magnet to densify the permanent Nd—Fe—B magnet. The step of sintering the permanent Nd—Fe—B magnet is further defined as diffusing a rare earth metal powder containing at least one of Terbium and Dysprosium into the permanent Nd—Fe—B magnet.

The next step of the method is drying the purified permanent Nd—Fe—B magnet. It should be appreciated that the step of drying the purified permanent Nd—Fe—B magnet can be performed using a furnace and at an elevated temperature of between 50° C. and 60° C. for a time duration of 30 minutes. Then, the purified permanent Nd—Fe—B magnet is disposed in a chamber of a multi-arc ion plating apparatus. The step of disposing the purified permanent Nd—Fe—B magnet in the chamber of the multi-arc ion plating apparatus is further defined as disposing the purified permanent Nd—Fe—B magnet on a jig in the chamber of the multi-arc ion plating apparatus. After disposing the purified permanent Nd—Fe—B magnet on the jig, the purified permanent Nd—Fe—B magnet is rotated on the jig in the chamber of the multi-arc ion plating apparatus.

Next, air is removed from the chamber of the multi-arc ion plating apparatus to lower pressure in the chamber of the multi-arc ion plating apparatus to a first reduced pressure of between 1.0×10⁻² Pa and 3.0×10⁻² Pa. After removing air, the next step of the method includes feeding an inert gas containing Argon having a purity of at least 99.7% into the chamber of the multi-arc ion plating apparatus to increase pressure in the chamber of the multi-arc ion plating apparatus to a first raised pressure of between 3.0×10⁻¹ Pa and 5.0×10⁻¹ Pa.

After the inert gas is fed into the chamber, an electric potential is applied to the purified permanent Nd—Fe—B magnet in the chamber of the multi-arc ion plating apparatus to clean the purified permanent Nd—Fe—B magnet. The step of applying the electric potential to the purified permanent Nd—Fe—B magnet is further defined as applying the electric potential between 800V and 1000V to the purified permanent Nd—Fe—B magnet in the chamber of the multi-arc ion plating apparatus for a time extent of between one and ten minutes to clean the purified permanent Nd—Fe—B magnet. It should be appreciated that, the electrical potential is generated by any means such as using a bias power supply. After applying the electric potential to the purified permanent Nd—Fe—B magnet, air is further removed from the chamber of the multi-arc ion plating apparatus to lower pressure in the chamber of the multi-arc ion plating apparatus to a second reduced pressure of between 1.0×10⁻³ Pa and 8.0×10⁻³ Pa. Then, the inert gas containing Argon having the purity of at least 99.7% is fed into the chamber of the multi-arc ion plating apparatus to increase pressure in the chamber of the multi-arc ion plating apparatus to the second raised pressure of between 3.0×10⁻¹Pa and 5.0×10⁻¹Pa.

The next step of the process includes depositing a first film of metal, e.g. aluminum, on the purified permanent Nd—Fe—B magnet using an arc source to produce a coated permanent Nd—Fe—B magnet. The step of depositing the first film of metal is further defined as depositing a film of metal having a thickness of between 0.5 μm and 15 μm using the arc source on the purified permanent Nd—Fe—B magnet. The step of depositing the first film of metal further includes a step of applying a current of between 50 A and 70 A and an electrical potential of between 100V and 200V to a target source of metal to produce a plurality of ions of metal. The step depositing the first film of metal further includes a step of directing the ions of metal using the arc source to the purified permanent Nd—Fe—B magnet for a time period of between 0.1 hour and 2 hours to produce the coated permanent Nd—Fe—B magnet.

The coated permanent Nd—Fe—B magnet is then cooled in the chamber of the multi-arc ion plating apparatus to an intermediate temperature of between 20° C. and 100° C. After cooling the coated permanent Nd—Fe—B magnet, the Nd—Fe—B magnet is removed from the chamber of the multi-arc ion plating apparatus. The next step of the process is depositing an anti-corrosive film on the coated permanent Nd—Fe—B magnet to produce a layered permanent Nd—Fe—B magnet. The layered permanent Nd—Fe—B magnet is then cured at a final temperature of between 100° C. and 220° C. and a time interval of between 10 minutes and 120 minutes. Alternatively, the step of curing may be further defined as curing the layered permanent Nd—Fe—B magnet at a first final temperature of 120° C. for a time interval of 30 minutes and curing the layered permanent Nd—Fe—B magnet at a second final temperature of 170° C. for a time interval of 30 minutes.

After curing the layered permanent Nd—Fe—B permanent magnet, the layered permanent Nd—Fe—B magnet is cooled to room temperature. Next, the anti-corrosive film on the layered permanent Nd—Fe—B magnet is measured and machined to define a breadth of between 5 μm and 40 μm. Prior to the step of curing the layered permanent Nd—Fe—B magnet, the step of depositing the anti-corrosive film is further defined as spraying the anti-corrosive film of a composite resin selected from epoxy or phenol on the coated permanent Nd—Fe—B magnet.

Prior to the step of removing air from the chamber of the multi-arc ion plating apparatus, the step of disposing the Nd—Fe—B magnet in the chamber of the multi-arc ion plating apparatus further includes a step of cooling the chamber and the arc source of the multi-arc ion plating apparatus to lower and maintain the temperature of the arc source to increase efficiency of the step of depositing the film of aluminum on the purified permanent Nd—Fe—B magnet. The step cooling the chamber and the arc source is further defined as feeding a fluid of water at a cooling temperature of between 0° C. and 5° C. through the chamber and the arc source.

Prior to the step of removing air from the chamber of the multi-arc ion plating apparatus, the method includes a step of adjusting the target source of metal and a control magnet of the arc source in the chamber of the multi-arc ion plating apparatus defining a predetermined distance of between 1 cm and 10 cm between the target source of metal and the control magnet of the arc source to increase the arc movement produced by the arc source prior to the step of removing air from the chamber of the multi-arc ion plating apparatus. It should be appreciated that the control magnet of the arc source is a N50 grade permanent magnet for controlling the movement of the arc source, e.g. rotational movements.

For a better understanding and of the present invention, exemplary examples of the present invention are set forth below. The exemplary examples are for illustrative purpose only and do not in limit the scope of the present invention.

### IMPLEMENTING EXAMPLE 1

For implementing example 1, an anti-corrosion layer is deposited on a permanent Nd—Fe—B magnet including grease and dust. The grease and the dust are first removed from the permanent Nd—Fe—B magnet to produce a purified permanent Nd—Fe—B magnet. The step of removing the grease and the dust further includes a step of washing the permanent Nd—Fe—B magnet using deionized water. After washing the permanent Nd—Fe—B magnet, the permanent Nd—Fe—B magnet is rinsed using an acidic solution including nitric acid being present in an amount of 4.0 wt % to remove the grease. After removing the grease, the permanent Nd—Fe—B magnet is washed using the deionized water. The permanent Nd—Fe—B magnet is then subjected to an ultrasonic rinsing process to remove the dust.

Because the deionized water used to wash the permanent Nd—Fe—B magnet may be trapped in the permanent Nd—Fe—B magnet, the deionized water is removed by submerging the permanent Nd—Fe—B magnet in a solution including alcohol being present of 99.8 wt. %. The permanent Nd—Fe—B magnet is then air-dried to produce the purified permanent Nd—Fe—B magnet.

Next, the purified permanent Nd—Fe—B magnet is dried in a furnace and at an elevated temperature of 55° C. for a time duration of 30 minutes. After drying, the purified permanent Nd—Fe—B magnet is disposed on a jig in the chamber of the multi-arc ion plating apparatus. Next, the chamber and the arc source of the multi-arc ion plating apparatus is cooled by feeding a fluid of water at a cooling temperature of 3° C. The jig including the purified permanent Nd—Fe—B magnet is then rotated in the chamber of the multi-arc ion plating apparatus. After rotating the jig, a target source of metal of aluminum and a control magnet including a N50 grade permanent magnet of the arc source in the chamber of the multi-arc ion plating apparatus are adjusted to define a predetermined distance of 5 cm between the target source of metal of aluminum and the control magnet of the arc source to increase the arc movement produced by the arc source.

Next, air is removed from the chamber of the multi-arc ion plating apparatus to lower pressure in the chamber of the multi-arc ion plating apparatus to a first reduced pressure of 2.0×10⁻² Pa. After removing air, an inert gas containing Argon having a purity of 99.8% into the chamber of the multi-arc ion plating apparatus to increase pressure in the chamber of the multi-arc ion plating apparatus to a first raised pressure of 2.0×10⁻¹ Pa. Then, an electric potential of 900V is applied to the purified permanent Nd—Fe—B magnet in the chamber of the multi-arc ion plating apparatus for a time extent of five minutes to clean the purified permanent Nd—Fe—B magnet.

After applying the electric potential, air is further removed from the chamber to lower pressure in the chamber of the multi-arc ion plating apparatus to a second reduced pressure of 6.0×10⁻³ Pa. Then, the inert gas containing Argon is further fed into the chamber of the multi-arc ion plating apparatus to increase pressure and provide the inert environment in the chamber of the multi-arc ion plating apparatus to the second raised pressure of 4.0×10⁻¹ Pa. Next, a film of metal of aluminum having a thickness of 10 μm is disposed on the purified permanent Nd—Fe—B magnet by applying a current of 60 A and an electrical potential of 150V to the target source of aluminum to produce a plurality of ions of aluminum and directing the ions of aluminum using the arc source to the purified permanent Nd—Fe—B magnet for a time period of 1.5 hours to produce a coated permanent Nd—Fe—B magnet.

The coated permanent Nd—Fe—B magnet is then cooled in the chamber of the multi-arc ion plating apparatus to an intermediate temperature of 80° C. After cooling, the coated permanent Nd—Fe—B magnet is removed from the chamber of the multi-arc ion plating apparatus.

Next, an anti-corrosive film is deposited on the coated permanent Nd—Fe—B magnet by spraying the anti-corrosive film of a composite resin of epoxy on the coated permanent Nd—Fe—B magnet to produce a layered permanent Nd—Fe—B magnet. The layered permanent Nd—Fe—B magnet is then cured at a final temperature of 220° C. and a time interval of 10 minutes. After curing the layered permanent Nd—Fe—B permanent magnet, the layered permanent Nd—Fe—B magnet is cooled to room temperature. Next, the anti-corrosive film on the layered permanent Nd—Fe—B magnet is measured and machined to define a breadth of 30 μm. The anti-corrosive coating obtained on the layered permanent Nd—Fe—B magnet has a dark black color and a smooth surface. There are protrusions, air bubbles or cracks on the layered permanent Nd—Fe—B magnet.

As set forth in the table below, the layered permanent Nd—Fe—B magnet obtained from implementing example 1 is compared with permanent Nd—Fe—B magnets including a film set forth in comparative examples 2 and 3. In comparative example 2, the film is deposited on the permanent Nd—Fe—B magnet by a multi-arc ion plating process. In comparative example 3, the film is deposited on the permanent Nd—Fe—B magnet by a spraying process. Total thickness of the film is the same for implementing example 1, comparative example 2, and comparative example 3. The comparison tests include a neutral salt spraying test (SST) and a pressure cooker test (PCT). The neutral salt spray test is conducted in accordance with the ISO 9227-2006 requirement by using a liquid containing 5 wt. % NaCl, at 35° C., and continuously sprayed. The pressure cooker test is performed under two times the atmospheric pressure, 100% relative humidity, and a temperature of 120° C.

TABLE 1

| | Method | Thick- | | | |
|---|---|---|---|---|---|
| | of Plating | ness | Surface | PCT | SST |
| Implementing | Method in | 40 μm | Smooth | 240 MPa | 2000 hrs |
| Example 1 | accordance | | | | with no |
| | with the Present | | | | Corrosion |
| | Invention | | | | |
| Comparative | Multi-arc ion | 40 μm | Rough | 200 MPa | Corrosion |
| Example 2 | plating process | | | | after |
| | | | | | 960 hrs |
| Comparative | Spraying | 40 μm | Smooth | 96 MPa | Corrosion |
| Example 3 | | | | | after |
| | | | | | 480 hrs |

### IMPLEMENTING EXAMPLE 2

For implementing example 2, an anti-corrosion layer is deposited on a permanent Nd—Fe—B magnet including grease and dust sintered by diffusing a rare earth metal powder containing Dysprosium (Dy) into the permanent Nd—Fe—B magnet. The grease and the dust are first removed from the permanent Nd—Fe—B magnet to produce a purified permanent Nd—Fe—B magnet. The step of removing the grease and the dust further includes a step of washing the permanent Nd—Fe—B magnet using deionized water. After washing the permanent Nd—Fe—B magnet, the permanent Nd—Fe—B magnet is rinsed using an acidic solution including nitric acid being present in an amount of 3.0 wt % to remove the grease. After removing the grease, the permanent Nd—Fe—B magnet is washed using the deionized water. The permanent Nd—Fe—B magnet is then subjected to an ultrasonic rinsing process to remove the dust.

Because the deionized water used to wash the permanent Nd—Fe—B magnet may be trapped in the permanent Nd—Fe—B magnet, the deionized water is removed by submerging the permanent Nd—Fe—B magnet in a solution including alcohol being present of 99.1 wt. %. The permanent Nd—Fe—B magnet is then air-dried to produce the purified permanent Nd—Fe—B magnet.

Next, the purified permanent Nd—Fe—B magnet is dried in a furnace and at an elevated temperature of 50° C. for a time duration of 30 minutes. After drying, the purified permanent Nd—Fe—B magnet is disposed on a jig in the chamber of the multi-arc ion plating apparatus. Next, the chamber and the arc source of the multi-arc ion plating apparatus is cooled by feeding a fluid of water at a cooling temperature of 0° C. The jig including the purified permanent Nd—Fe—B magnet is then rotated in the chamber of the multi-arc ion plating apparatus. After rotating the jig, a target source of metal of aluminum and a control magnet including a N50 grade permanent magnet of the arc source in the chamber of the multi-arc ion plating apparatus are adjusted to define a predetermined distance of 1 cm between the target source of metal of aluminum and the control magnet of the arc source to increase the arc movement produced by the arc source.

Next, air is removed from the chamber of the multi-arc ion plating apparatus to lower pressure in the chamber of the multi-arc ion plating apparatus to a first reduced pressure of 1.0×10⁻² Pa. After removing air, an inert gas containing Argon having a purity of 99.71% into the chamber of the multi-arc ion plating apparatus to increase pressure in the chamber of the multi-arc ion plating apparatus to a first raised pressure of 1.0×10⁻¹ Pa. Then, an electric potential of 800V is applied to the purified permanent Nd—Fe—B magnet in the chamber of the multi-arc ion plating apparatus for a time extent of one minute to clean the purified permanent Nd—Fe—B magnet.

After applying the electric potential, air is further removed from the chamber to lower pressure in the chamber of the multi-arc ion plating apparatus to a second reduced pressure of 1.0×10⁻³ Pa. Then, the inert gas containing Argon is further fed into the chamber of the multi-arc ion plating apparatus to increase pressure and provide the inert environment in the chamber of the multi-arc ion plating apparatus to the second raised pressure of 3.0×10⁻¹ Pa. Next, a film of metal of aluminum having a thickness of 0.5 μm is disposed on the purified permanent Nd—Fe—B magnet by applying a current of 50 A and an electrical potential of 100V to the target source of aluminum to produce a plurality of ions of aluminum and directing the ions of aluminum using the arc source to the purified permanent Nd—Fe—B magnet for a time period of 0.1 hour to produce a coated permanent Nd—Fe—B magnet.

The coated permanent Nd—Fe—B magnet is then cooled in the chamber of the multi-arc ion plating apparatus to an intermediate temperature of 20° C. After cooling, the coated permanent Nd—Fe—B magnet is removed from the chamber of the multi-arc ion plating apparatus.

Next, an anti-corrosive film is deposited on the coated permanent Nd—Fe—B magnet by spraying the anti-corrosive film of a composite resin of epoxy on the coated permanent Nd—Fe—B magnet to produce a layered permanent Nd—Fe—B magnet. The layered permanent Nd—Fe—B magnet is then cured at a final temperature of 100° C. and a time interval of 120 minutes. After curing the layered permanent Nd—Fe—B permanent magnet, the layered permanent Nd—Fe—B magnet is cooled to room temperature. Next, the anti-corrosive film on the layered permanent Nd—Fe—B magnet is measured and machined to define a breadth of 40 μm. The anti-corrosive coating obtained on the layered permanent Nd—Fe—B magnet has a dark black color and a smooth surface. There are protrusions, air bubbles or cracks on the layered permanent Nd—Fe—B magnet.

As set forth in the table below, the layered permanent Nd—Fe—B magnet obtained from implementing example 2 is compared with permanent Nd—Fe—B magnets including a film set forth in comparative examples 4 and 5. In comparative example 4, the film is deposited on the permanent Nd—Fe—B magnet by a multi-arc ion plating process. In comparative example 5, the film is deposited on the permanent Nd—Fe—B magnet by a spraying process. Total thickness of the film is the same for implementing example 2, comparative example 4, and comparative example 5. The comparison tests include a neutral salt spraying test (SST) and a pressure cooker test (PCT). The neutral salt spray test is conducted in accordance with the ISO 9227-2006 requirement by using a liquid containing 5 wt. % NaCl, at 35° C., and continuously sprayed. The pressure cooker test is performed under two times the atmospheric pressure, 100% relative humidity, and a temperature of 120° C.

TABLE 2

| | Method | Thick- | | | |
|---|---|---|---|---|---|
| | of Plating | ness | Surface | PCT | SST |
| Implementing | Method in | 40.5 μm | Smooth | 240 MPa | 2010 hrs |
| Example 2 | accordance | | | | with no |
| | with the Present | | | | Corrosion |
| | Invention | | | | |
| Comparative | Multi-arc ion | 40.5 μm | Rough | 200 MPa | Corrosion |
| Example 4 | plating process | | | | after |
| | | | | | 967 hrs |
| Comparative | Spraying | 40.5 μm | Smooth | 96 MPa | Corrosion |
| Example 5 | | | | | after |
| | | | | | 500 hrs |

### IMPLEMENTING EXAMPLE 3

For implementing example 3, an anti-corrosion layer is deposited on a permanent Nd—Fe—B magnet including grease and dust sintered by diffusing a rare earth metal powder containing Terbium (Tb) into the permanent Nd—Fe—B magnet. The grease and the dust are first removed from the permanent Nd—Fe—B magnet to produce a purified permanent Nd—Fe—B magnet. The step of removing the grease and the dust further includes a step of washing the permanent Nd—Fe—B magnet using deionized water. After washing the permanent Nd—Fe—B magnet, the permanent Nd—Fe—B magnet is rinsed using an acidic solution including nitric acid being present in an amount of 5.0 wt % to remove the grease. After removing the grease, the permanent Nd—Fe—B magnet is washed using the deionized water. The permanent Nd—Fe—B magnet is then subjected to an ultrasonic rinsing process to remove the dust.

Because the deionized water used to wash the permanent Nd—Fe—B magnet may be trapped in the permanent Nd—Fe—B magnet, the deionized water is removed by submerging the permanent Nd—Fe—B magnet in a solution including alcohol being present of 99.9 wt. %. The permanent Nd—Fe—B magnet is then air-dried to produce the purified permanent Nd—Fe—B magnet.

Next, the purified permanent Nd—Fe—B magnet is dried in a furnace and at an elevated temperature of 60° C. for a time duration of 30 minutes. After drying, the purified permanent Nd—Fe—B magnet is disposed on a jig in the chamber of the multi-arc ion plating apparatus. Next, the chamber and the arc source of the multi-arc ion plating apparatus is cooled by feeding a fluid of water at a cooling temperature of 5° C. The jig including the purified permanent Nd—Fe—B magnet is then rotated in the chamber of the multi-arc ion plating apparatus. After rotating the jig, a target source of metal of aluminum and a control magnet including a N50 grade permanent magnet of the arc source in the chamber of the multi-arc ion plating apparatus are adjusted to define a predetermined distance of 10 cm between the target source of metal of aluminum and the control magnet of the arc source to increase the arc movement produced by the arc source.

Next, air is removed from the chamber of the multi-arc ion plating apparatus to lower pressure in the chamber of the multi-arc ion plating apparatus to a first reduced pressure of 3.0×10⁻² Pa. After removing air, an inert gas containing Argon having a purity of 99.9% into the chamber of the multi-arc ion plating apparatus to increase pressure in the chamber of the multi-arc ion plating apparatus to a first raised pressure of 5.0×10⁻¹ Pa. Then, an electric potential of 1000V is applied to the purified permanent Nd—Fe—B magnet in the chamber of the multi-arc ion plating apparatus for a time extent of ten minutes to clean the purified permanent Nd—Fe—B magnet.

After applying the electric potential, air is further removed from the chamber to lower pressure in the chamber of the multi-arc ion plating apparatus to a second reduced pressure of 8.0×10⁻³ Pa. Then, the inert gas containing Argon is further fed into the chamber of the multi-arc ion plating apparatus to increase pressure and provide the inert environment in the chamber of the multi-arc ion plating apparatus to the second raised pressure of 5.0×10⁻² Pa. Next, a film of metal of aluminum having a thickness of 15 μm is disposed on the purified permanent Nd—Fe—B magnet by applying a current of 70 A and an electrical potential of 200V to the target source of aluminum to produce a plurality of ions of aluminum and directing the ions of aluminum using the arc source to the purified permanent Nd—Fe—B magnet for a time period of 2 hours to produce a coated permanent Nd—Fe—B magnet.

The coated permanent Nd—Fe—B magnet is then cooled in the chamber of the multi-arc ion plating apparatus to an intermediate temperature of 100° C. After cooling, the coated permanent Nd—Fe—B magnet is removed from the chamber of the multi-arc ion plating apparatus.

Next, an anti-corrosive film is deposited on the coated permanent Nd—Fe—B magnet by spraying the anti-corrosive film of a composite resin of phenol on the coated permanent Nd—Fe—B magnet to produce a layered permanent Nd—Fe—B magnet. The layered permanent Nd—Fe—B magnet is cured at a first final temperature of 120° C. for a first time interval of 30 minutes and a second final temperature of 170° C. for a second time interval of 30 minutes. After curing the layered permanent Nd—Fe—B permanent magnet, the layered permanent Nd—Fe—B magnet is cooled to room temperature. Next, the anti-corrosive film on the layered permanent Nd—Fe—B magnet is measured and machined to define a breadth of 5 μm. The anti-corrosive coating obtained on the layered permanent Nd—Fe—B magnet has a dark black color and a smooth surface. There are protrusions, air bubbles or cracks on the layered permanent Nd—Fe—B magnet.

As set forth in the table below, the layered permanent Nd—Fe—B magnet obtained from implementing example 3 is compared with permanent Nd—Fe—B magnets including a film set forth in comparative examples 6 and 7. In comparative example 6, the film is deposited on the permanent Nd—Fe—B magnet by a multi-arc ion plating process. In comparative example 7, the film is deposited on the permanent Nd—Fe—B magnet by a spraying process. Total thickness of the film is the same for implementing example 3, comparative example 6, and comparative example 7. The comparison tests include a neutral salt spraying test (SST) and a pressure cooker test (PCT). The neutral salt spray test is conducted in accordance with the ISO 9227-2006 requirement by using a liquid containing 5 wt. % NaCl, at 35° C., and continuously sprayed. The pressure cooker test is performed under two times the atmospheric pressure, 100% relative humidity, and a temperature of 120° C.

TABLE 3

| | Method | Thick- | | | |
|---|---|---|---|---|---|
| | of Plating | ness | Surface | PCT | SST |
| Implementing | Method in | 20 μm | Smooth | 160 MPa | 960 hrs |
| Example 3 | accordance | | | | with no |
| | with the Present | | | | Corrosion |
| | Invention | | | | |
| Comparative | Multi-arc ion | | | | Corrosion |
| Example 6 | plating process | 20 μm | Rough | 72 MPa | after |
| | | | | | 360 hrs |
| Comparative | Spraying | 20 μm | Smooth | 72 MPa | Corrosion |
| Example 7 | | | | | after |
| | | | | | 240 hrs |

As indicated by Table 1, Table 2, and Table 3, depositing a composite layer on the permanent Nd—Fe—B magnet in accordance with the present invention provides for a better efficiency and improved corrosion resistance thereby providing a better utilization prospective.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims. In addition, the reference numerals in the claims are merely for convenience and are not to be read in any way as limiting.

What is claimed is:

1. A method for depositing a composite film on a permanent Nd—Fe—B magnet including grease and dust using a multi-arc ion plating apparatus defining a chamber and including a target source of metal disposed in the chamber and a jig disposed in the chamber and rotatably attached to the multi-arc ion plating apparatus and an arc source including a control magnet disposed in the chamber, said method comprising the steps of;
removing grease and dust from a permanent Nd—Fe—B magnet to produce a purified permanent Nd—Fe—B magnet,
disposing the purified permanent Nd—Fe—B magnet in a chamber of a multi-arc ion plating apparatus,
removing air from the chamber of the multi-arc ion plating apparatus to lower pressure in the chamber of the multi-arc ion plating apparatus to a first reduce pressure,
applying an electric potential to the purified permanent Nd—Fe—B magnet in the chamber of the multi-arc ion plating apparatus to clean the purified permanent Nd—Fe—B magnet,
depositing a first film of metal on the purified permanent Nd—Fe—B magnet using an arc source to produce a coated permanent Nd—Fe—B magnet,
depositing an anti-corrosive film on the coated permanent Nd—Fe—B magnet to produce a layered permanent Nd—Fe—B magnet,
said step of depositing the anti-corrosive film being further defined as spraying the anti-corrosive film of a composite resin on the coated permanent Nd—Fe—B magnet.

2. The method as set forth in claim 1 wherein said step of depositing the anti-corrosive film is further defined as spraying the anti-corrosive film of the composite resin of epoxy on the coated permanent Nd—Fe—B magnet.

3. The method as set forth in claim 1 wherein said step of depositing the anti-corrosive film is further defined as spraying the anti-corrosive film of the composite resin of phenol on the coated permanent Nd—Fe—B magnet.

4. The method as set forth in claim 1 further includes a step of curing the layered permanent Nd—Fe—B magnet at a final temperature of between 100° C. and 220° C. and a time interval of between 10 minutes and 120 minutes.

5. The method as set forth in claim 4 wherein said step of curing is further defined as curing the layered permanent Nd—Fe—B magnet at a first final temperature of 120° C. for a first time interval of 30 minutes and at a second final temperature of 170° C. for a second time interval of 30 minutes.

6. The method as set forth in claim 1 wherein said step of disposing purified permanent Nd—Fe—B magnet in the chamber of the multi-arc ion plating apparatus further including a step of cooling the chamber and the arc source of the multi-arc ion plating apparatus to lower and maintain the temperature of the arc source to increase efficiency of said step of depositing the film of metal on the purified permanent Nd—Fe—B magnet.

7. The method as set forth in claim 6 wherein said step cooling the chamber and the arc source is further defined as feeding a fluid of water at a cooling temperature of between 0° C. and 5° C. through the chamber and the arc source.

8. The method as set forth in claim 1 further includes a step of adjusting the target source of metal and a control magnet of the arc source in the chamber of the multi-arc ion plating apparatus defining a predetermined distance of between 1 cm and 10 cm between the target source of metal and the control magnet of the arc source to increase the arc movement produced by the arc source prior to said step of removing air from the chamber of the multi-arc ion plating apparatus.

9. The method as set forth in claim 1 further includes a step of sintering a permanent Nd—Fe—B magnet to densify the permanent Nd—Fe—B magnet prior to said step of removing the grease and the dust from the permanent Nd—Fe—B magnet.

10. The method as set forth in claim 9 wherein said step of sintering the permanent Nd—Fe—B magnet is further defined as diffusing a rare earth metal powder containing at least one of Terbium and Dysprosium into the permanent Nd—Fe—B magnet.

11. The method as set forth in claim 1 wherein said step of depositing the first film of metal is further defined as depositing the first film of metal of aluminum having a thickness of between 0.5 μm and 15 μm using the arc source on the purified permanent Nd—Fe—B magnet.

12. The method as set forth in claim 11 wherein said step of said step of depositing the first film of metal further includes a step of applying a current of between 50 A and 70 A and an electrical potential of between 100V and 200V to a target source of metal to produce a plurality of ions of metal.

13. The method as set forth in claim 12 wherein said step depositing the first film of metal further includes a step of directing the ions of metal using the arc source to the purified permanent Nd—Fe—B magnet for a time period of between 0.1 hour and 2 hours to produce the coated permanent Nd—Fe—B magnet.
